(19) United States
(12) Patent Application Publication
(10) Pub. No.: US 2008/0289733 A1
(43) Pub. Date: Nov. 27, 2008

(54) High-Energy Materials with Encapsulated Fluid Components

(76) Inventor: Alon Gany, Haifa (IL)

Correspondence Address: Pearl Cohen Zedek Latzer, LLP, 1500 Broadway, 12th Floor, New York, NY, 10036, US

(21) Appl. No.: 11/883,828

(22) PCT Filed: Feb. 7, 2006
(86) PCT No.: PCT/IL2006/000152

§ 371 Date: May 5, 2008

(30) Foreign Application Priority Data
Feb. 10, 2005 (IL) 166797

(51) Int. Cl. C06B 45/00; C06B 47/14

(52) U.S. Cl. 149/1; 149/2

(57) ABSTRACT

A high-energy material composition comprising solid matrix with encapsulated fluid component embedded in the matrix.

### FIELD OF THE INVENTION

The present invention relates to high-energy materials, particularly propellants, with encapsulated fluid components.

### BACKGROUND OF THE INVENTION

High-energy materials comprise propellants, explosives, and pyrotechnic materials, and generally include all the components required for their intended chemical reaction.

Rocket engines are characterized by inclusion of all the components required to generate the thrust with no need for external oxygen. There are two main types of chemical rocket engines: liquid engines and solid motors. Typically, liquid engines provide better energetic performance than solid motors, but are more complex, expensive, more cumbersome to maintain and store, and contain many parts and components that may increase failure probability.

Solid motors are simpler than liquid engines in their design and operation, and this constitutes a main advantage over the liquid engines. This characteristic renders solid motors more popular for use, over a wide range of tasks and sizes, ranging from small anti-tank rockets, weighting a few hundred grams, to huge space rocket boosters, weighting dozens or even hundreds of tons.

The main category of modern solid propellants (known as “composite propellants”) is based on a polymeric fuel binder (e.g. hydroxyl-terminated-polybutadiene, also known as HTPB), which constitutes a continuous matrix, containing dispersed grainy or powdered components, which include an oxidizer (usually ammonium perchlorate, NH₄ClO₄, also known as AP, which is an inorganic salt in crystalline particulate form), and often also a fine powder of a metallic substance with high heat of combustion, the latter being frequently aluminum (Al). Typically, the oxidizer composes most of the composite propellant mass.

The characteristic parameter indicative of the energetic performance of a propellant is its specific impulse Iₛₚ (defined as the ratio between the thrust and the weight flow rate of the propellant), measured in units of seconds. The greater the specific impulse is, the lower the propellant mass required for a given task. Specific impulse is approximately proportional to the square root of the heat of combustion per unit of mass.

The main drawback of solid propellants is their relatively low energetic performance: their typical specific impulse (Iₛₚ) usually ranges between 200 to 250 seconds, whereas the specific impulse of liquid propellants is typically in the range of about 250 to 400 seconds. This mainly stems from the fact that those solid oxidizers, which are practically available for use, exhibit lower energetic performance with respect to available liquid oxidizers. The most commonly used solid oxidizer, namely ammonium perchlorate, when used with common polymeric fuels, exhibits relatively low heat of combustion (about 1 kcal/g), as a result of a negative enthalpy of formation of a high absolute value, and a significant quantity of inert components or components having low heat of combustion in the ammonium perchlorate molecule (N, Cl). On the other hand, liquid propellant combinations such as oxygen and kerosene or oxygen and hydrogen are characterized by a higher theoretical heat of combustion of 2.4 kcal/g and 3.2 kcal/g, respectively.

Encapsulation is a method of avoidance of contact between incompatible components. U.S. Pat. No. 4,758,289 (Walters) describes the manufacturing of waterproof microcapsules of a free-running blasting agent.

U.S. Pat. No. 3,767,488 (Seals) presents a method of reducing sensitivity of explosive compositions to moisture by coating the composition particles with silane monomer capable of reacting with atmospheric moisture to form a water impermeable polymer. Another method of reducing sensitivity of ammonium-nitrate-based explosives to water by a protective water resistant grease coating is described in U.S. Pat. No. 3,287,189 (Wilson et al.).

U.S. Pat. No. 5,049,212 (Colick) suggests the incorporation of an encapsulated explosive yield enhancer into an explosive mix. The main idea is that the encapsulation of a highly reactive oxidizer, which may otherwise destabilize the explosive, in close contact with an inorganic fuel component, can provide higher rates of reaction and heat liberation, thereby enhancing the explosive yield. Explosive yield enhancers are selected from the group: halogens, interhalogens and halides.

Safety and compatibility reasons have yielded a number of patents in the field of solid rocket propellants:

U.S. Pat. No. 3,995,559 (Bice et al.) suggests a solid propellant comprising a plurality of alternating layers of solid fuel and solid oxidizer encapsulated by polytetrafluoroethylene and a polymeric adhesive, with adjacent layers being bonded together at confronting surfaces by the polymeric adhesive. U.S. Pat. No. 3,677,010 (Fink et al.) discloses a solid propellant rocket motor comprising layers of metal fuel and oxidant bound within a matrix. A solid propellant comprising concentric tubular alternating layers of oxidizer and fuel components, where a polymer barrier coating encapsulates each layer, is disclosed in U.S. Pat. No. 5,714,711 (Schumacher et al.).

Generally, the patents dealing with explosives stress the use of encapsulation to reduce sensitivity either to ambient conditions (humidity) or to premature detonation due to contact between highly reactive components.

As described hereinabove, the main objective of the patents concerning solid propellants is to increase safety by providing physical separation between the typical solid propellant components. Hence, a different structural shape (alternating layers containing fuel and oxidizer components separately) is proposed.

None of the above patents have proposed a propellant with improved energetic performance, where a major component of a substantial fraction of the propellant mass (most effectively the solid oxidizer) is replaced by a higher energy encapsulated fluid-state component, maintaining the general structure of the solid propellant grain.

Combining solid fuel with liquid oxidizers has been tested for hybrid rocket engines, where liquid oxidizer is injected into a void in a hollow cylinder of a solid polymeric fuel. This type of rocket engines is characterized by a higher specific impulse than solid motors, but evidently its disadvantage lies in the greater complexity of hybrid engines, with respect to solid motors, and greater complexity of the combustion process and interior ballistics of hybrid engines, resulting in hybrid engines being rarely used in actual projects.

### SUMMARY OF THE INVENTION

There is thus provided, in accordance with some preferred embodiments of the present invention, a high-energy material composition comprising solid matrix with encapsulated fluid component embedded in the matrix.

Furthermore, in accordance with some preferred embodiments of the present invention, the matrix comprises a solid fuel.

Furthermore, in accordance with some preferred embodiments of the present invention, the solid fuel comprises HTPB.

Furthermore, in accordance with some preferred embodiments of the present invention, the matrix comprises a solid propellant.

Furthermore, in accordance with some preferred embodiments of the present invention, the solid propellant comprises AP.

Furthermore, in accordance with some preferred embodiments of the present invention, the matrix comprises an explosive.

Furthermore, in accordance with some preferred embodiments of the present invention, the matrix comprises a pyrotechnic material.

Furthermore, in accordance with some preferred embodiments of the present invention, the fluid component comprises a liquid.

Furthermore, in accordance with some preferred embodiments of the present invention, the fluid component comprises a gel.

Furthermore, in accordance with some preferred embodiments of the present invention, the fluid component comprises a gas.

Furthermore, in accordance with some preferred embodiments of the present invention, the encapsulated fluid component comprises a fluid component encased in metallic capsules.

Furthermore, in accordance with some preferred embodiments of the present invention, the metallic capsules are made from aluminum.

Furthermore, in accordance with some preferred embodiments of the present invention, the encapsulated fluid component comprises a fluid component encased in non-metallic capsules.

Furthermore, in accordance with some preferred embodiments of the present invention, the non-metallic capsules are made from polymeric materials that are compatible with the encapsulated fluid component.

Furthermore, in accordance with some preferred embodiments of the present invention, the non-metallic capsules are made from polytetrafluoroethylene (PTFE).

Furthermore, in accordance with some preferred embodiments of the present invention, the non-metallic capsules are made from polyethylene.

Furthermore, in accordance with some preferred embodiments of the present invention, the encapsulated fluid component comprises an oxidizer.

Furthermore, in accordance with some preferred embodiments of the present invention, the oxidizer is selected from the group consisting of H₂O₂, N₂O₄, N₂O, HNO₃ fuming or non-fuming, and O₂.

Furthermore, in accordance with some preferred embodiments of the present invention, the oxidizer comprises a fluorine-based oxidizer.

Furthermore, in accordance with some preferred embodiments of the present invention, the encapsulated component comprises hydride.

Furthermore, in accordance with some preferred embodiments of the present invention, there is provided a component for incorporation with a high-energy material, comprising a plurality of hollow capsules encapsulating fluid components.

Furthermore, in accordance with some preferred embodiments of the present invention, the capsules contain liquid oxidizer.

Furthermore, in accordance with some preferred embodiments of the present invention, the capsules contain gaseous oxidizer.

Furthermore, in accordance with some preferred embodiments of the present invention, the capsules contain gel oxidizer.

Furthermore, in accordance with some preferred embodiments of the present invention, the capsules contain hydride.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates the structural formation of a portion of a solid propellant with encapsulated components, in accordance with a preferred embodiment of the present invention.

FIG. 2 illustrates the first stage in the manufacturing of encapsulated components in accordance with a preferred embodiment of the present invention—the filling of a thin metal tube with liquid or gaseous component.

FIG. 3 illustrates the second stage in the manufacturing of encapsulated components in accordance with a preferred embodiment of the present invention—forming capsules in the tube.

FIG. 4 illustrates the third stage in the manufacturing of encapsulated components in accordance with a preferred embodiment of the present invention—separating of the capsules.

### DETAILED DESCRIPTION OF PREFERRED EMBODIMENTS

The present invention provides a novel category of solid high-energy materials enhanced by fluid chemical components. For the sake of example we mainly discuss solid propellants, yet it is noted that the present invention relates to any kind of solid high-energy materials.

A main aspect of the present invention is the provision of encapsulated fluid component in solid high-energy materials (such as solid propellants used in rocket motors). A major potential advantage of this is the ability to introduce encapsulated liquid oxidizers into solid propellants, hence substantially increasing the heat of combustion of the propellant. However, introduction of other components, for example, liquid or gaseous fuel, is also an object of the present invention, and is covered by the scope of the invention.

Similarly to solid oxidizers, which are distributed in a solid propellant in the form of small particles in a continuous polymeric binder (fuel), the present invention suggests distributing small capsules containing liquid oxidizer within the solid propellant. The overall configuration of the solid propellant is maintained in structural terms, and the combustion process remains basically similar. It is estimated that energetically speaking, the present invention can potentially increase the specific impulse of the propellant by as much as 5 to 15 percent compared with available solid propellants, rendering the present invention a significant, if not altogether revolutionary, improvement.

Attempts to increase the performance of solid propellants by as little as a few percents are made today at tremendous costs. Generally speaking, these attempts involve developing high-cost energetic components, which may carry high safety risks (most bearing explosive characteristics). The present invention, on the other hand, can be based on using conventional propellant components, which are known, but in a novel approach, and with a substantially greater potential to increase the specific impulse.

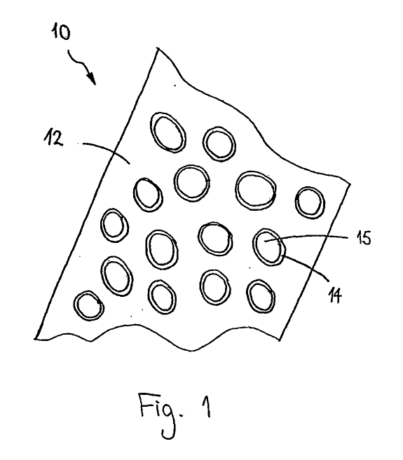

Reference is made to FIG. 1 illustrating the structural formation of a portion of a solid propellant 10 with encapsulated components, in accordance with a preferred embodiment of the present invention. The solid propellant typically comprises polymeric fuel matrix 12 with embedded capsules 14 filled with fluid (liquid, gas, or gel) components 15, such as oxidizers.

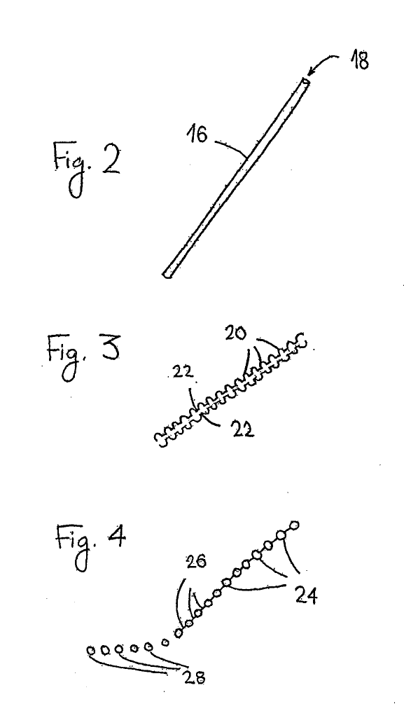

In a preferred embodiment of the present invention capsules are provided in the form of hollow particles, preferably made from aluminum, filled with a fluid component (typically oxidizer, but other component may be used). In one suggested method of manufacturing these filled capsules, a thin tube of aluminum is used (see FIG. 2). The tube 16 is filled with the fluid component 18, either directly, or by dipping the tube into a container filled with the fluid component, and then clipping the small capsules 20 (see FIG. 3, note that this may be carried out by pressing the wall of the tube 22 together at predetermined locations along the tube, thus forming capsules 20) and sealing them (sealing may be achieved by squashing the ends of the tube on either sides of the capsule, or by using other sealing method). Then (See FIG. 4) the capsules may be separated (28) or—in a less likely scenario, yet an optional one—kept together in the form of a string 26 (the capsules 24 being separated by the squashed tube walls portions).

Various methods of production may be used in the manufacturing of the capsules. For example, non-metallic capsules may be produced using a two-fluid extrusion method.

In another preferred embodiment of the present invention the fluid component used is in the form of gel.

In case of gaseous contents, the filling, cutting and sealing of the capsules is preferably carried out under high-pressure conditions of the filling gas, so that the gaseous contents of the capsule be substantial (i.e. sufficient enough for effective use). Pressure in the order of 1000 atmospheres could be the required pressure level in typical use. Working under high-pressure conditions may complicate the manufacturing process compared to atmospheric pressure, when a liquid component is used. Alternatively, the gaseous component may be filled into the tubes in cooled liquefied or frozen form, allowing it to warm up later and return to its gaseous form, under increased internal pressure within the capsule.

The capsule casing itself may be manufactured from various materials. Aluminum is recommended as it is a common component in rocket propellants, but other materials can be considered too (for example PTFE, polyethylene, or other polymeric materials that are compatible with the encapsulated components).

As mentioned hereinbefore, the immediate application of the present invention is in the form of encapsulated oxidizer to be embedded in solid fuel or propellant.

Several storable oxidizers may be considered. The simple ones among liquid oxidizers include H₂O₂ (hydrogen peroxide), HNO₃ (nitric acid), “fuming” or “non-fuming”, N₂O and N₂O₄ (nitrogen tetroxide). Fluorine-based oxidizers may be considered too. As for gaseous oxidizers—oxygen (O₂) seems like one of the best choices. Oxidizer in gel form may also be used.

However, fluid components other than oxidizers can be encapsulated and used too, for example fuel components and additives like hydrides.

In some preferred embodiments of the present invention, different encapsulated components may be embedded in the solid matrix (i.e. some encapsulated fluid components that are different than other encapsulated fluid components used in the same solid propellant, as well as different types of encapsulating materials).

As for the fuel itself—modern composite solid propellants that are commonly used to date are based on polybutadiene, which is a polymeric fuel (binder)—typically hydroxyl-terminated-polybutadiene (HTPB), which is commonly used as a solid fuel in 11 to 16 percent of mass content, ammonium perchlorate (NH₄ClO₄, also known as AP) in 63 to 73 percent, and aluminum in 15 to 22 percent. Note that other solid fuels may be used too, and are covered by the scope of the present invention. In addition, it is noted that certain other propellants may not include metal additives at all, but are still covered by the scope of the present invention. In the latter cases the typical percentage of the oxidizer is higher.

The maximal theoretical specific impulse value for a propellant type mentioned hereinabove under standard conditions is about 266 seconds (for a composition of 11% HTPB, 67% NH₄ClO₄, 22% Al, assuming equilibrium flow). For a “frozen flow” the performance slightly degrades. (Iₛₚ=258 seconds).

Theoretical calculations indicate that by using HTPB as binder, with encapsulated oxidizers, in accordance with the present invention, performance is significantly increased:

For a composition of 15% HTPB, 55% H₂O₂ (concentration 90%) and 30% Al, the theoretical specific impulse Iₛₚ is 282 seconds.

For a composition of 20% HTPB, 62% N₂O₄ and 18% Al, the theoretical specific impulse Iₛₚ is 283 seconds.

For a composition of 25% HTPB, 57% O₂ and 18% Al, the theoretical specific impulse Iₛₚ is 298 seconds (!).

In order to achieve the desired content ratio between oxidizer and aluminum (when the encapsulating material is aluminum), the ratio between the thickness of the capsule wall and the diameter of the capsule (for spherical capsules) has to be properly adjusted.

Based on theoretical values in equilibrium flow, the potential of improvement attributed to the present invention, vis a vis specific impulse, compared with the best performance of conventional HTPB/AP/Al compositions of solid propellants, is approximately 6 percent—if H₂O₂ (90% in concentration) is used as oxidizer, 6 percent—if N₂O₄ is used, and as much as 12 percent—if O₂ is used.

It is noted that ammonium perchlorate needs not be fully replaced by a liquid oxidizer, but in case of partial replacement performance is expected to be lower than for a full replacement.

The present invention introduces another advantage in terms of safety, both in manufacture and in the storing. In the manufacturing process handling of ammonium perchlorate (solid oxidizer) is dangerous. It may respond to friction, grinding or other action by igniting or exploding. The mixing of this oxidizer with the polymeric binder fuel is also highly risky, and at the end of the manufacturing process the fuel and oxidizer remain in physical contact.

In the present invention oxidizers are used that are typically less sensitive than ammonium perchlorate. There is no physical contact between the oxidizer and the fuel throughout the manufacturing process and later during the storing stage, thus significantly reducing inadvertent ignition and combustion.

It is recommended to prevent the existence of too large aluminum capsules inside the combustion chamber, so that their burning time is not too long. It is anticipated that capsules in the order of dozens or hundreds of microns be suitable for use in the compositions mentioned hereinabove.

The present invention may be applied in military and civic applications, mainly in rockets, ranging from artillery rockets to ballistic missiles and spacecraft launchers and boosters. It may be also applied in pyrotechnic applications, and explosives, where energetic performance can be greatly improved.

It should be clear that the description of the embodiments and attached Figures set forth in this specification serves only for a better understanding of the invention, without limiting its scope as covered by the following Claims.

It should also be clear that a person skilled in the art, after reading the present specification, could make adjustments or amendments to the attached Figures and above described embodiments that would still be covered by the following Claims.

1. A high-energy material composition comprising solid matrix with encapsulated fluid component embedded in the matrix.

2. The composition of claim 1, wherein the matrix comprises a solid fuel.

3. The composition of claim 2, wherein the solid fuel comprises HTPB.

4. The composition of claim 1, wherein the matrix comprises a solid propellant.

5. The composition of claim 4, wherein the solid propellant comprises AP.

6. The composition of claim 1, wherein the matrix comprises an explosive.

7. The composition of claim 1, wherein the matrix comprises a pyrotechnic material.

8. The composition of claim 1, wherein the fluid component comprises a liquid.

9. The composition of claim 1, wherein the fluid component comprises a gel.

10. The composition of claim 1, wherein the fluid component comprises a gas.

11. The composition of claim 1, wherein the encapsulated fluid component comprises a fluid component encased in metallic capsules.

12. The composition of claim 11, wherein the metallic capsules are made from aluminum.

13. The composition of claim 1, wherein the encapsulated fluid component comprises a fluid component encased in non-metallic capsules.

14. The composition of claim 13, wherein the non-metallic capsules are made from polymeric materials that are compatible with the encapsulated fluid component.

15. The composition of claim 13, wherein the non-metallic capsules are made from polytetrafluoroethylene (PTFE).

16. The composition of claim 13, wherein the non-metallic capsules are made from polyethylene.

17. The composition of claim 1, wherein the encapsulated fluid component comprises an oxidizer.

18. The composition of claim 17, wherein the oxidizer is selected from the group consisting of H₂O₂, N₂O₄, N₂O, HNO₃ fuming or non-fuming, and O₂.

19. The composition of claim 17, wherein the oxidizer comprises a fluorine-based oxidizer.

20. The high-energy material of claim 1, wherein the encapsulated component comprises hydride.

21. A component for incorporation with a high-energy material, comprising a plurality of hollow capsules encapsulating fluid components.

22. The components of claim 21, wherein the capsules contain liquid oxidizer.

23. The components of claim 21, wherein the capsules contain gaseous oxidizer.

24. The components of claim 21, wherein the capsules contain gel oxidizer.

25. The components of claim 21, wherein the capsules contain hydride.
